(19) United States
(12) Patent Application Publication
(10) Pub. No.: US 2014/0056369 A1
(43) Pub. Date: Feb. 27, 2014

(54) Control Traffic Overhead Reduction during Network Setup in PLC Networks

(71) Applicant: TEXAS INSTRUMENTS INCORPORATED, Dallas, TX (US)

(72) Inventors: Ramanuja Vedantham, Allen, TX (US); Kumaran Vijayasankar, Dallas, TX (US); Xiaolin Lu, Plano, TX (US)

(73) Assignee: TEXAS INSTRUMENTS INCORPORATED, Dallas, TX (US)

(21) Appl. No.: 13/971,638

(22) Filed: Aug. 20, 2013

Related U.S. Application Data
(60) Provisional application No. 61/691,594, filed on Aug. 21, 2012.

(51) Int. Cl. H04B 3/54

(52) U.S. Cl. CPC H04B 3/544
USPC 375/257

(57) ABSTRACT

A power line communication device connected to a power line communication network that includes a transceiver to transmit messages to a plurality of nodes on the network and to receive messages from the plurality of nodes on the network, and a processor coupled to the transceiver to evaluate received messages and generate messages to transmit. The processor, upon receiving a promotion needed message from an additional power line communication (PLC) device joining the network, is to determine whether data communication has already been established with a base node of the network, determine whether the device is already seeking promotion to be a switch node or has already been promoted to the switch node, and determine a signal quality of the received promotion needed message from the additional PLC device joining the network. Based on those determinations, the processor is to adjust a frequency at which to transmit a promotion request based on a number of promotion requests received from the plurality of other nodes on the network and a number of promotion needed messages received.

### CROSS-REFERENCE TO RELATED APPLICATION

The present application claims priority to U.S. Provisional Patent Application No. 61/691,594, filed on Aug. 20, 2012 (Attorney Docket No. TI-72766); which is hereby incorporated herein by reference.

### BACKGROUND

There are several different types of communication networks available today. For example, power line communications (PLC) include systems for communicating data over the same medium (i.e., a wire or conductor) that is also used to transmit electric power to residences, buildings, and other premises. Once deployed, PLC systems may enable a wide array of applications, including, for example, automatic meter reading and load control (i.e., utility-type applications), automotive uses (e.g., charging electric cars), home automation (e.g., controlling appliances, lights, etc.), and/or computer networking (e.g., Internet access), to name only a few.

For each different type of communications network, different standardizing efforts are commonly undertaken throughout the world. For instance, in the case of PLC communications may be implemented differently depending upon local regulations, characteristics of local power grids, etc. Examples of competing PLC standards include the PoweRline Intelligent Metering Evolution (PRIME) standard designed for OFDM-based (Orthogonal Frequency-Division Multiplexing) communications. Another PLC standardization effort includes, for example, the IEEE 1901, HomePlug AV, and ITU-T G.hn (e.g., G.9960 and G.9961) specifications.

The size and adoption of PLC networks are continuing to grow in various parts of the globe. As with any growth, the data traffic on these networks, both data packets and control packets, is beginning to create traffic overhead constraints. As such, reducing traffic may allow the continued growth and stability of PLC networks. The reduction of traffic may occur in reducing the amount of data transmitted, reducing the number of control messages transmitted or a combination of the two, for example.

### SUMMARY

One technique to control traffic overhead reduction during network setup in PLC networks is a PLC device connected to a PLC network that includes a transceiver to transmit messages to a plurality of nodes on the network and to receive messages from the plurality of nodes on the network, and a processor coupled to the transceiver to evaluate received messages and generate messages to transmit. The processor, upon receiving a promotion needed message from an additional power line communication (PLC) device joining the network, is to determine whether data communication has already been established with a base node of the network, determine whether the device is already seeking promotion to be a switch node or has already been promoted to the switch node, and determine a signal quality of the received promotion needed message from the additional PLC device joining the network. Based on those determinations, the processor is to adjust a frequency at which to transmit a promotion request based on a number of promotion requests received from the plurality of other nodes on the network and a number of promotion needed messages received.

Another technique to control traffic overhead reduction during network setup in PLC networks is a PLC modem in a PLC network containing a plurality of PLC modems, the PLC modem including a transceiver to receive promotion needed protocol data unit (PNPDU) frames and to transmit promotion request (PRO_REQ_S) frames, wherein a PNPDU frame may be received from a modem attempting to join the network, a memory storing software to control the modem's actions when PNPDU frames are received, and a processor to execute the software when PNPDU frames are received. The processor is to determine whether the modem has already established a data communication with a base node, determine whether the modem is already being promoted to a switch node or is already a switch node, and determine a signal quality of the received PNPDU frame. Based on the data communication having already been established with the base node, the modem is not already being promoted to nor is already the switch node, and the signal quality of the received PNPDU frame is greater than a threshold, the modem is to determine the frequency at which to transmit the PRO_REQ_S frames based on a number of PRO_REQ_S frames received from other modems on the PLC network and based on a number of PNPDU frames received from modems attempting to join the network, wherein the frequency is proportional to a number of PNPDU frames received between transmissions of the PRO_REQ_S frame by the modem.

And yet another technique to control traffic overhead reduction during network setup in PLC networks is a method for promoting a terminal node of a power line communication network to a switch node that includes receiving, by a first terminal node of a power line communication network, a promotion needed message from a second terminal node, wherein the promotion needed message is requesting the first terminal node to seek promotion to become a switch node, determining, by the first terminal node, whether the first terminal node has already established data connection with the base node, determining, by the first terminal node, whether the first terminal node has not already been promoted or is not already seeking promotion to become the switch node, and determining, by the first terminal node, a signal quality level of the promotion needed message received from the second terminal node. Based on determining that the first terminal node has already established data connection with the base node, that the first terminal node is not already seeking promotion to change to the switch mode or is not already promoted to the switch node, and that the signal quality level is above a threshold, determining, by the first terminal node, a frequency at which to transmit the promotion requests based on a number of promotion requests received from a plurality of other terminal nodes on the network and the number of promotion needed messages received, wherein a promotion request is a message from the first terminal node to the base node requesting the terminal node be changed to the switch node.

### BRIEF DESCRIPTION OF THE DRAWINGS

For a detailed description of exemplary embodiments of the invention, reference will now be made to the accompanying drawings in which:

FIG. 1 is a block diagram of a power line communication (PLC) environment according to some embodiments.

FIG. 2 is a block diagram of a PLC device or modem according to some embodiments.

FIG. 3 is a block diagram of an integrated circuit according to some embodiments.

FIG. 4 is a block diagrams illustrating connections between a PLC transmitter and/or receiver circuitry to three-phase power lines according to some embodiments.

FIG. 5 is a block diagram of a computing system configured to implement certain systems and methods described herein according to some embodiments.

FIG. 6 is a schematic diagram of nodes in an illustrative PLC network following the PRIME standard according to some embodiments as discussed herein.

FIG. 7 is an example sequence that shows the communications that occur and the algorithms performed by the various nodes of a PLC network when a new node joins the network under the PRIME standard as discussed herein.

FIG. 8 is an illustrative flow chart of the PRO_REQ_S frame reduction algorithm under the PRIME standard as discussed herein.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

As used herein, the terms “node” may refer to a modem or device connected to a PLC network at a building or residence. A node may be one of several types and may depend on the topology of the network. PRIME-based PLC networks, for example, may be designed in a tree topology as opposed to a mesh topology. As such, a terminal node may be an end point, or a leaf, of the tree. A switch node may retransmit data between a terminal node and a beacon node (data concentrator). The beacon node may be the root of the tree or subnetwork of a larger PLC network.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In some power line communication (PLC) networks, such as PRIME networks, a node joins through a switch node or data concentrator and uses that node for communication with a base node. However, the act of a node or nodes joining the network may set off an abundance of messages that may unnecessarily add to the traffic on the PLC network, which may also lead to network problems. The abundance of messages may be due to a large number of terminal nodes (TNs) that request to be switched from a TN to a switch node (SN) so the nodes joining the network may register with and communicate with that neighborhood's beacon node (BN). As used herein, a subnetwork of a larger PLC network may be referred to as a neighborhood. Conventionally, each TN that receives a message from a node attempting to join the network would send a request for promotion, essentially a one-to-one ratio. This, however, may be a large increase in traffic when a large number of nodes attempts to join a network that already has a large number of nodes connected.

In various embodiments, the systems and methods described herein may be used to reduce the number of promotion request (PRO_REQ_S) frames transmitted by TNs seeking to be promoted to SNs when new TNs are attempting to join the network or subnetwork. In response to the new nodes attempting to join the network, each TNs may reduce the number of PRO_REQ_S frames transmitted to the neighborhood BN based on the number of other PRO_REQ_S frames received from other TNs in the neighborhood and the number of nodes seeking to join the network. The new nodes attempting to join the network may transmit a promotion needed protocol data unit (PNPDU) frame/message that may be received by the local TNs. The adjusted PRO_REQ_S frame transition rate/frequency may be based on waiting for a number of PNPDUs frames to be received between transmitting PRO_REQ_S frames.

As noted, the PRIME PLC network may utilize a tree topology, which may also be viewed as levels. For instance, a BN may be at a higher level than a SN, which may be at a higher level than a TN. In this view, a new node attempting to join the network would likely be a TN since it would be at the lowest level. If, for example, there are only two levels (a BN level and a TN level) before a node or nodes attempts to join the network, the third level of new nodes would likely all be TN and one or more nodes on the second level may be promoted to a SN so that the new nodes on level three may begin to communicate with the BN. The TNs on level two that are promoted to SN may begin to relay messages/packets/data between the new TNs and the BN. The process of becoming a SN may, however, increase the traffic on the network since all TNs on level two may attempt to be promoted in response to the new TNs joining the network.

Generally speaking, the disclosed systems and methods may be applicable to a wide variety of communication environments, including, but not limited to, those involving wireless communications (e.g., cellular, Wi-Fi, WiMax, etc.), wired communications (e.g., Ethernet, etc.), power line communications (PLC), or the like. For ease of explanation, several examples discussed below are described specifically in the context of PLC. However, certain techniques and principles disclosed herein may also be applicable to other communication environments.

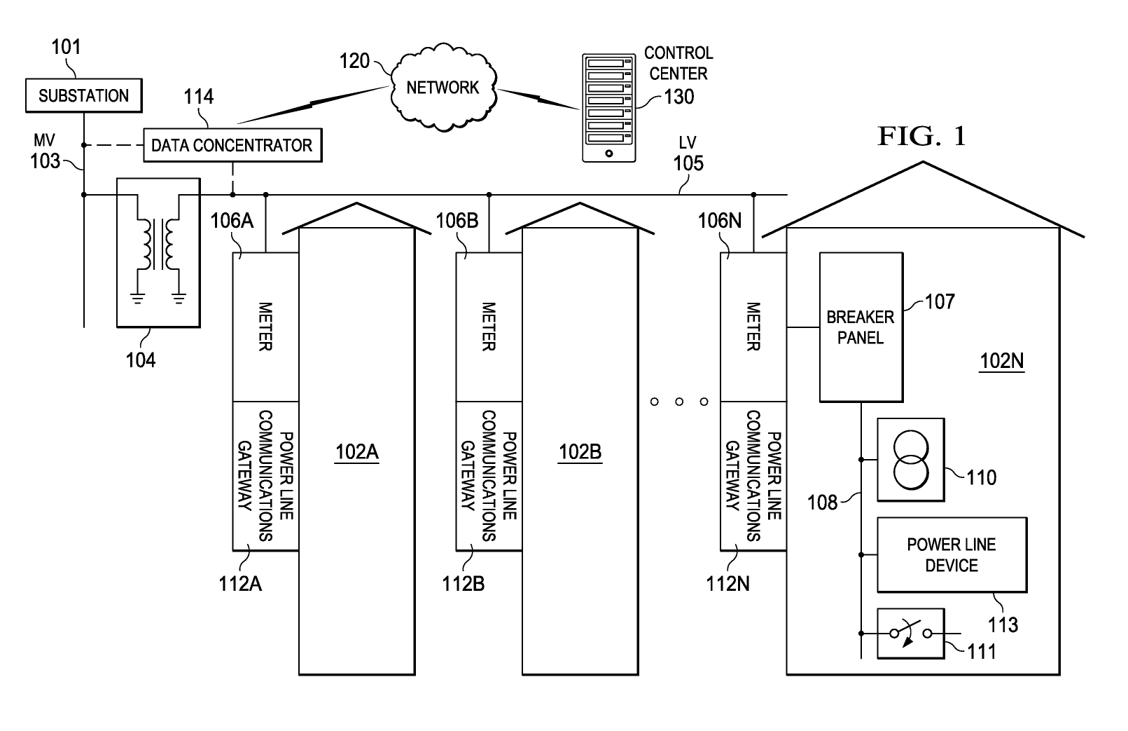

Turning now to FIG. 1, an example of an electric power distribution system is shown. Medium voltage (MV) power lines 103 from substation 101 typically carry voltage in the tens of kilovolts range. Transformer 104 steps the MV power down to low voltage (LV) power on LV lines 105, carrying voltage in the range of 100-240 VAC. Transformer 104 may operate at low frequencies in the range of 50-60 Hz. Transformer 104 may not allow high frequencies, such as signals greater than 100 KHz, to pass between LV lines 105 and MV lines 103. LV lines 105 feed power to customers via meters 106a-n, which are typically mounted on the outside of residences 102a-n. (Although referred to as “residences,” premises 102a-n may include any type of building, facility or location where electric power is received and/or consumed.) A breaker panel, such as panel 107, provides an interface between meter 106n and electrical wires 108 within residence 102n. Electrical wires 108 deliver power to outlets 110, switches 111 and other electric devices within residence 102n.

The power line topology illustrated in FIG. 1 may be used to deliver high-speed communications to residences 102a-n. In some implementations, power line communications modems or gateways 112a-n may be coupled to LV power lines 105 at meter 106a-n. PLC modems/gateways 112a-n may be used to transmit and receive data signals over MV/LV lines 103/105. Such data signals may be used to support metering and power delivery applications (e.g., smart grid applications), communication systems, high speed Internet, telephony, video conferencing, and video delivery, to name a few. By transporting telecommunications and/or data signals over a power transmission network, there is no need to install new cabling to each subscriber 102a-n. Thus, by using existing electricity distribution systems to carry data signals, significant cost savings are possible.

An illustrative method for transmitting data over power lines may use, for example, a carrier signal having a frequency different from that of the power signal. The carrier signal may be modulated by the data, for example, using an orthogonal frequency division multiplexing (OFDM) scheme or the like.

PLC modems or gateways, also referred to as nodes, 112a-n at residences 102a-n use the MV/LV power grid to carry data signals to and from PLC data concentrator 114 without requiring additional wiring. Concentrator 114 may be coupled to either MV line 103 or LV line 105. Modems or gateways 112a-n may support applications such as high-speed broadband Internet links, narrowband control applications, low bandwidth data collection applications, or the like. In a home environment, for example, modems or gateways 112a-n may further enable home and building automation in heat and air conditioning, lighting, and security. Also, PLC modems or gateways 112a-n may enable AC or DC charging of electric vehicles and other appliances. An example of an AC or DC charger is illustrated as PLC device 113. Outside the premises, power line communication networks may provide street lighting control and remote power meter data collection.

One or more data concentrators 114 may be coupled to control center 130 (e.g., a utility company) via network 120. Network 120 may include, for example, an IP-based network, the Internet, a cellular network, a WiFi network, a WiMax network, or the like. As such, control center 130 may be configured to collect power consumption and other types of relevant information from gateway(s) 112 and/or device(s) 113 through concentrator(s) 114. Additionally or alternatively, control center 130 may be configured to implement smart grid policies and other regulatory or commercial rules by communicating such rules to each gateway(s) 112 and/or device(s) 113 through concentrator(s) 114.

In some embodiments, each concentrator 114 may be seen as a base node for a PLC domain, each such domain comprising downstream PLC devices that communicate with control center 130 through a respective concentrator 114. For example, in FIG. 1, device 106a-n, 112a-n, and 113 may all be considered part of the PLC domain that has data concentrator 114 as its base node; although in other scenarios other devices may be used as the base node of a PLC domain. In some implementations, multiple nodes may be deployed in a given PLC network, and at least a subset of those nodes may be tied to a common clock through a backbone (e.g., Ethernet, digital subscriber loop (DSL), etc.). Further, each PLC domain may be coupled to MV line 103 through its own distinct transformer similar to transformer 104.

Still referring to FIG. 1, meter 106, gateways 112, PLC device 113, and data concentrator 114 may each be coupled to or otherwise include a PLC modem or the like. The PLC modem may include transmitter and/or receiver circuitry to facilitate the device's connection to power lines 103, 105, and/or 108.

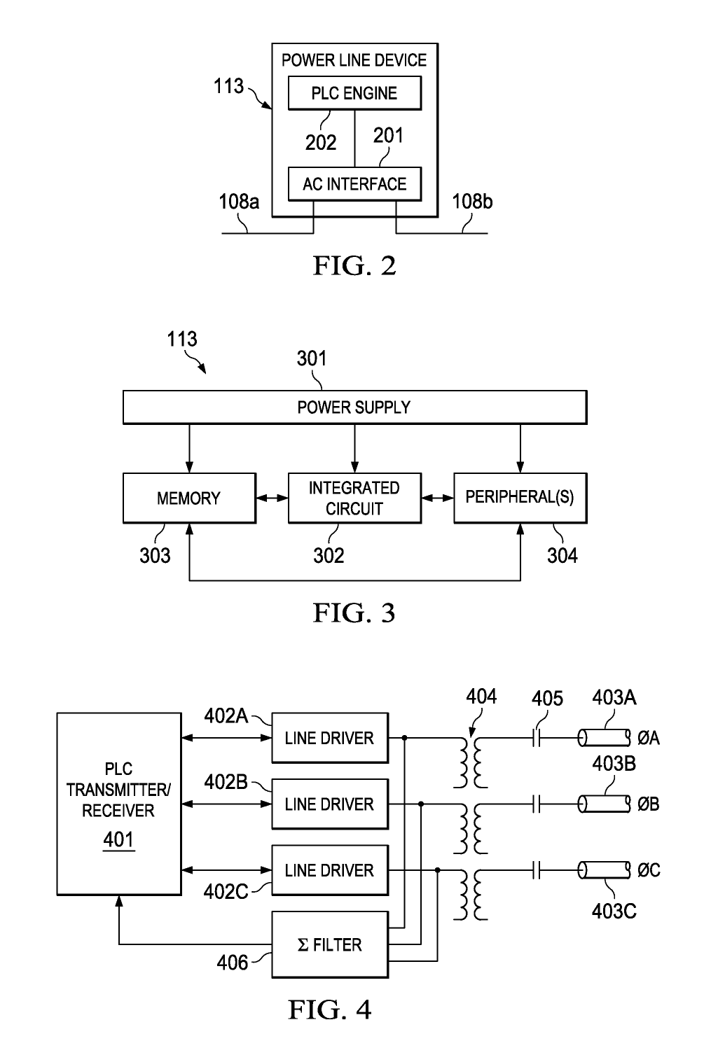

FIG. 2 is a block diagram of an illustrative PLC device or modem 113 according to some embodiments. As illustrated, AC interface 201 may be coupled to electrical wires 108a and 108b inside of premises 112n in a manner that allows PLC device 113 to switch the connection between wires 108a and 108b off using a switching circuit or the like. In other embodiments, however, AC interface 201 may be connected to a single wire 108 (i.e., without breaking wire 108 into wires 108a and 108b) and without providing such switching capabilities. In operation, AC interface 201 may allow PLC engine 202 to receive and transmit PLC signals over wires 108a-b. As noted above, in some cases, PLC device 113 may be a PLC modem. Additionally or alternatively, PLC device 113 may be a part of a smart grid device (e.g., an AC or DC charger, a meter, etc.), an appliance, or a control module for other electrical elements located inside or outside of premises 112n (e.g., street lighting, etc.).

PLC engine 202 may be configured to transmit and/or receive PLC signals over wires 108a and/or 108b via AC interface 201 using a particular channel or frequency band. In some embodiments, PLC engine 202 may be configured to transmit OFDM signals, although other types of modulation schemes may be used. As such, PLC engine 202 may include or otherwise be configured to communicate with metrology or monitoring circuits (not shown) that are in turn configured to measure power consumption characteristics of certain devices or appliances via wires 108, 108a, and/or 108b. PLC engine 202 may receive such power consumption information, encode it as one or more PLC signals, and transmit it over wires 108, 108a, and/or 108b to higher-level PLC devices (e.g., PLC gateways 112n, data concentrators 114, etc.) for further processing. Conversely, PLC engine 202 may receive instructions and/or other information from such higher-level PLC devices encoded in PLC signals, for example, to allow PLC engine 202 to select a particular frequency band in which to operate.

In various embodiments, PLC device 113 may be implemented at least in part as an integrated circuit. FIG. 3 is a block diagram of such an integrated circuit. In some cases, one or more of meter 106, gateway 112, PLC device 113, or data concentrator 114 may be implemented similarly as shown in FIG. 3. For example, integrated circuit 302 may be a digital signal processor (DSP), an application specific integrated circuit (ASIC), a system-on-chip (SoC) circuit, a field-programmable gate array (FPGA), a microprocessor, a microcontroller, or the like. As such, integrated circuit 302 may implement, at least in part, at least a portion of PLC engine 202 shown in FIG. 2. Integrated circuit 302 is coupled to one or more peripherals 304 and external memory 303. Further, integrated circuit 302 may include a driver for communicating signals to external memory 303 and another driver for communicating signals to peripherals 304. Power supply 301 is also provided which supplies the supply voltages to integrated circuit 302 as well as one or more supply voltages to memory 303 and/or peripherals 304. In some embodiments, more than one instance of integrated circuit 302 may be included (and more than one external memory 303 may be included as well).

Peripherals 304 may include any desired circuitry, depending on the type of PLC device or system. For example, in some embodiments, peripherals 304 may implement, at least in part, at least a portion of a PLC modem (e.g., portions of AC interface 210 shown in FIG. 2). Peripherals 304 may also include additional storage, including RAM storage, solid-state storage, or disk storage. In some cases, peripherals 304 may include user interface devices such as a display screen, including touch display screens or multi-touch display screens, keyboard or other input devices, microphones, speakers, etc. External memory 303 may include any type of memory. For example, external memory 303 may include SRAM, nonvolatile RAM (NVRAM, such as “flash” memory), and/or dynamic RAM (DRAM) such as synchronous DRAM (SDRAM), double data rate (DDR, DDR2, DDR3, etc.) SDRAM, etc. External memory 303 may include one or more memory modules to which the memory devices are mounted, such as single inline memory modules (SIMMs), dual inline memory modules (DIMMs), etc.

In various implementations, PLC device or modem 113 may include transmitter and/or receiver circuits configured to connect to power lines 103, 105, and/or 108. FIG. 4 illustrates a connection between the power line communication transmitter and/or receiver circuitry to the power lines according to some embodiments. PLC transmitter/receiver 401 may function as the transmitter and/or receiver circuit and may also be referred to as a transceiver. When PLC transmitter/receiver 401 operates as a transmitter, it may generate pre-coded signals for transmission over the power line network. Each output signal, which may be a digital signal, may be provided to a separate line driver circuit 402A-C. Line drivers 402A-C may comprise, for example, digital-to-analog conversion circuitry, filters, and/or line drivers that couple signals from PLC transmitter/receiver 401 to power lines 403A-C. Transformer 404 and coupling capacitor 405 link each analog circuit/line driver 402 to its respective power line 403A-C. Accordingly, in the embodiment illustrated in FIG. 4, each output signal is independently linked to a separate, dedicated power line. Conversely, when PLC transmitter/receiver 401 operates as a receiver, coded signals may be received on power lines 403A-C, respectively. In an embodiment, each of these signals may be individually received through coupling capacitors 405, transformers 404, and line drivers 402 to PLC transmitter/receiver 401 for detection and receiver processing of each signal separately. Alternatively, the received signals may be routed to summing filter 406, which combines all of the received signals into one signal that is routed to PLC transmitter/receiver 401 for receiver processing.

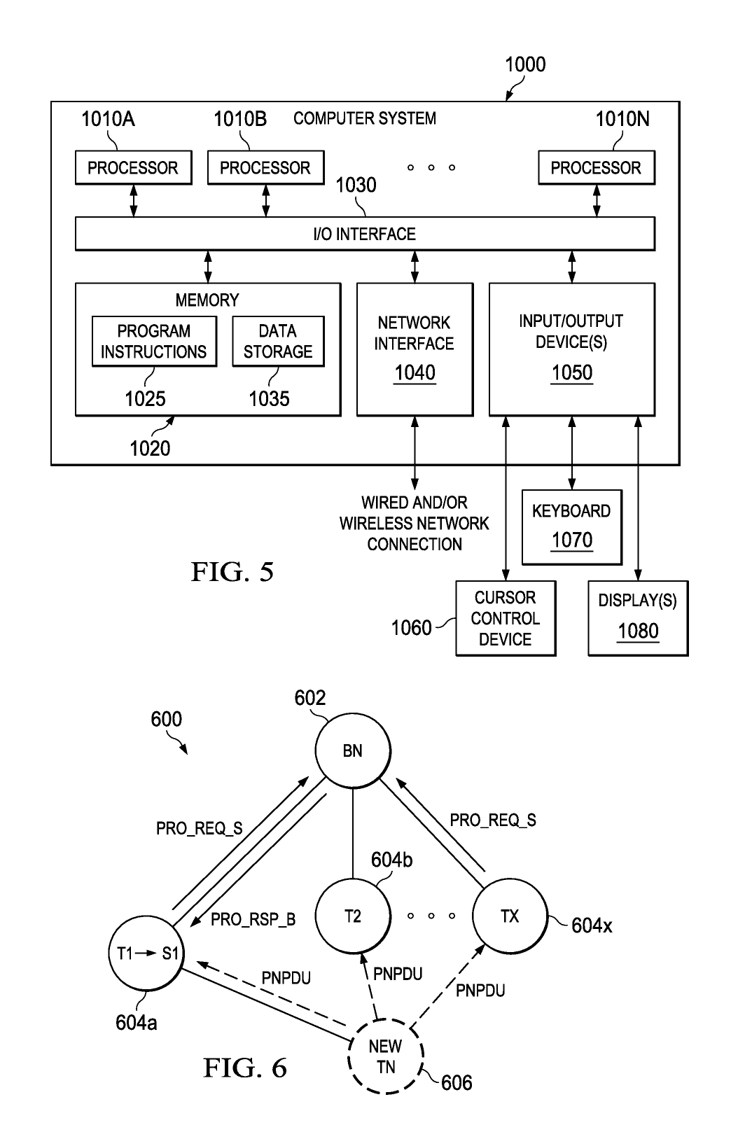

In various embodiments, one or more of the techniques described herein may be executed, at least in part, by one or more communication devices and/or computer systems. One such computer system is illustrated in FIG. 5. In various embodiments, system 1000 may be implemented as a communication device, modem, data concentrator, server, a mainframe computer system, a workstation, a network computer, a desktop computer, a laptop, mobile device, or the like. In different embodiments, these various systems may be configured to communicate with each other in any suitable way, such as, for example, via a local area network or the like.

As illustrated, system 1000 includes one or more processors 1010 coupled to a system memory 1020 via an input/output (I/O) interface 1030. Computer system 1000 further includes a network interface 1040 (coupled to I/O interface 1030, and one or more input/output devices, such as cursor control device 1060 (e.g., mouse, trackpad, etc.), keyboard 1070, and/or display(s) 1080.

System memory 1020 may be configured to store program instructions and/or data accessible by processor 1010. In various embodiments, system memory 1020 may be implemented using any suitable type of non-transitory storage device, such as static random access memory (SRAM), synchronous dynamic RAM (SDRAM), nonvolatile/Flash-type memory, or any other type of memory. As illustrated, program instructions and data implementing certain operations such as, for example, those described in the figures above, may be stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. The various operations described herein as attributed to a node of the PLC network may be implemented by the processors 1010 executing the program instructions. Generally speaking, a non-transitory, computer-accessible medium may include any tangible storage media or memory media such as magnetic or optical media—e.g., disk or CD/DVD-ROM coupled to computer system 1000 via I/O interface 1030. Program instructions and data stored on a tangible computer-accessible medium in non-transitory form may further be transmitted by transmission media or signals such as electrical, electromagnetic, or digital signals, which may be conveyed via a communication medium such as a network and/or a wireless link, such as may be implemented via network interface 1040.

Network interface 1040 may be configured to allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol. The network interface is a communications interface and may implement at least some of the power line interface circuitry shown in FIGS. 2-4.

FIG. 6 is a schematic diagram of nodes in an illustrative PLC network 600 following the PRIME standard according to some embodiments. The PRIME standard permits various subnetworks of nodes to exist and communicate with one another. FIG. 6 illustrates one such subnetwork as PLC network 600 and includes a base node 602 which may be a PLC data concentrator or the like, and which is shown, for example, as element 114 in FIG. 1. The base node is at the root of the network tree and functions as a master node that provides connectivity to the subnetwork. The base node manages the subnetwork resources and connections. All other nodes in the network (i.e., nodes 604a-x and 606) may generally be referred to as “service” nodes. A service node may communicate directly with the base node 602 or may communicate with the base node 602 via other service nodes or switch nodes. A service node may not be able to communicate directly with the base node due to the distance between the service and base nodes, intervening transformers, intervening service nodes, etc. Each of the nodes 602, 604a-x and 606 in FIG. 6 may be implemented consistent with the embodiments shown in FIGS. 1-5. FIG. 6 further refers to the process of a new node, a TN 606, joining the network 600.

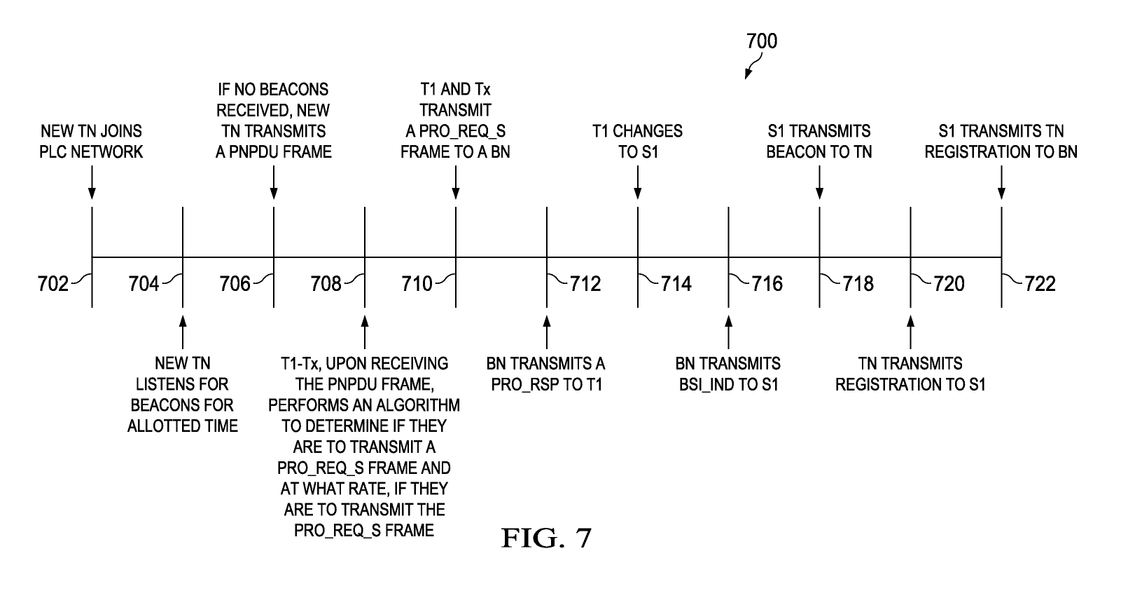

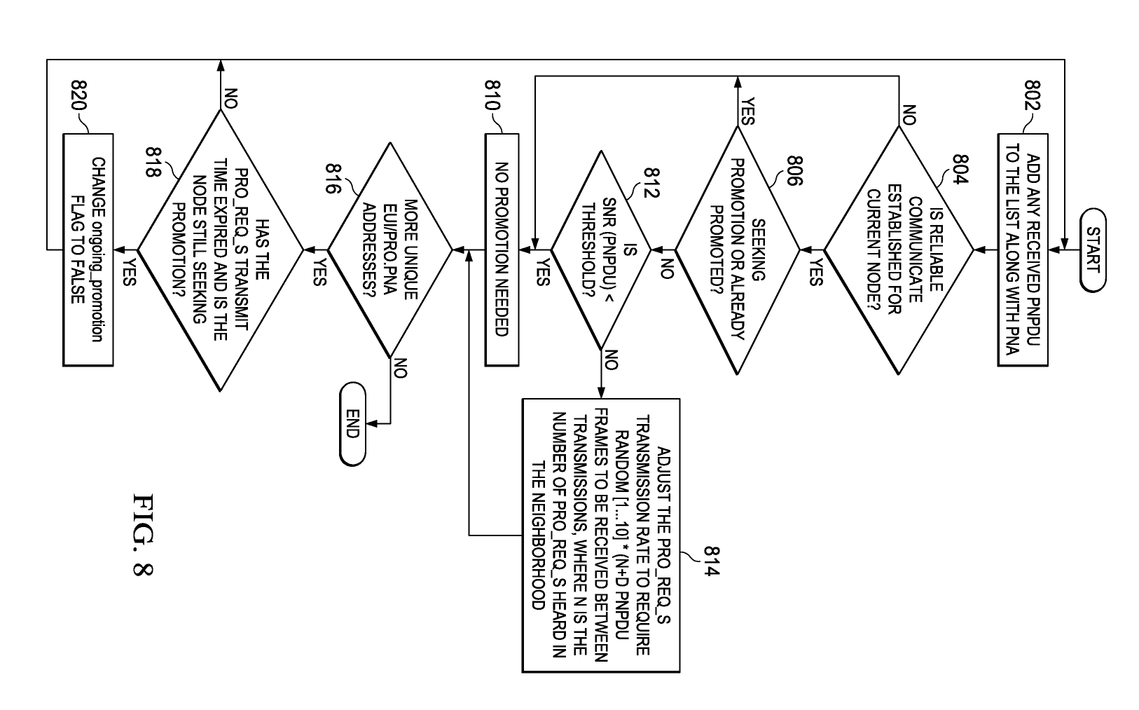

FIG. 7 is an example sequence 700 that shows the communications that occur and the algorithms performed by the various nodes of a PLC network such as the network 600 when a new node joins the network. Although the various steps on the sequence 700 may have an associated time defined by the PRIME standard, the sequence 700 may only show the steps of the process and not any actual timers associated with the various steps. The actions of the various nodes of the network 600 and their corresponding timing as shown in FIG. 7 will be described together.

As new TN 606 joins the network 600 of FIG. 6 at step 702 of FIG. 7, the TN 606 may listen for beacons, transmitted by BN 602 for example, for a standard required amount of time, 40 seconds for example, (step 704). The TN 606 may not receive any beacons because the nodes at the higher level, TNs 604a-x, being in a terminal node status, which may not allow them to transmit beacons. A terminal node may only be able to send and receive messages from a beacon node or a switch node and may not transmit beacons. A switch node may transmit beacons and relay messages and data between beacon nodes and terminal nodes.

At step 706, if the TN 606 has not received any beacons, then the TN 606 may begin transmitting PNPDU frames. Each PNPDU frame is a message requesting that any terminal nodes, such as the TNs 604a-x, in communication with a BN, such as BN 602, should seek to be promoted from a terminal node to a switch node. The local BN may select which TN node to promote to a switch node from the TN nodes requesting promotion. Once a TN is promoted to a switch node, the switch node may begin transmitting beacons to the new nodes that joined the network. As a switch node, the node may relay messages and data between the new terminal node(s) and the beacon node.

In response to receiving a PNPDU, a terminal node, such as T1 604a, may transmit a request to be promoted to their neighborhood beacon node, as noted. The promotion request may be a PRO_REQ_S message that informs the beacon node that the terminal node is seeking promotion to a switch node so that the node may begin transmitting beacons and relaying information between terminal nodes on a lower level of the subnetwork and the beacon node at a higher level. The PRO_REQ_S message may inform the beacon node of the address of the TN seeking/requesting promotion.

At step 708, any of the a-x TNs 604 that receives the PNPDU frames may begin performing a PRO_REQ_S frame reduction algorithm. The algorithm may limit the number of nodes transmitting the PRO_REQ_S frames and adjust the rate the allowed nodes transmit the PRO_REQ_S frames to the BN 602 with the overarching aim to reduce the number of PRO_REQ_S frames transmitted by all the nodes seeking promotion. The algorithm, to be described below in reference to FIG. 8, may reduce the rate or frequency at which to transmit the PRO_REQ_S frames from a base rate, if a node determines that it may transmit the PRO_REQ_S frame. The base rate may be a one-to-one ratio with the receipt of unique PNPDU frames received. A PNPDU frame may contain a unique identifier address, also referred to as a PNA (promotion needed address), that uniquely identifies the joining node. As such, in reference to FIG. 6, since there is one new TN 606 shown, each of the TNs 604a-x may transmit one PRO_REQ_S frames in response to the received promotion needed message or PNPDU. If, however, there were three new nodes with each new node transmitting a PNPDU, then each of the TN 604a-x may transmit three PRO_REQ_S frames in response. In the later scenario, that may result in a-x times three number of PRO_REQ_S frames transmitted. If, x is 100, then there would be 300 PRO_REQ_S frames transmitted. As one can see, the more terminal nodes already on the network and the more new nodes joining the network the larger the number of PRO_REQ_S frames that may be generated concurrently leading to increased overhead for the network. Thus, the PRO_REQ_S reduction algorithm may be used to reduce the number of PRO_REQ_S frames transmitted when nodes join a network.

FIG. 6 shows that that all nodes receive the PNPDU frames but that only nodes T1 and TX transmit a PRO_REQ_S frame in response. This illustrates that node T2 has determined that it may not transmit the PRO_REQ_S frame due to the algorithm, which will be described in detail below.

Referring back to FIG. 7, at step 710 the T1 604a and the TX 604x may both transmit a PRO_REQ_S frame to the BN 602. The BN 602 at step 712 may decide which TN 604 to promote and, as shown in FIG. 6, the BN 602 transmits a PRO_RSP_B frame to the T1 604a. The PRO_RSP_B frame may inform the node that they are to be promoted to a switch node from a terminal node. Upon T1 604a receiving the PRO_RSP from BN 602, T1 at step 714 changes from a terminal node to a switch node (represented in FIG. 6 with “T1→S1”) so that S1 may begin behaving as a relay or router to transmit beacons to the TN 606 and retransmit packets between the TN 606 and the BN 602.

At step 716, BN 602 may transmit a beacon slot indicator message (BSI_IND) to S1 604a. The steps 716 to 722 are not shown in FIG. 6. The BSI-IND message may contain the beacon slot details so that S1 does not transmit beacons during the same times as the beacons transmitted by the BN 602. At step 718, the S1 604a, now having been promoted to switch node status, may transmit beacons to the TN 606. At step 720 and in response to receiving a beacon, the TN 606 may transmit its registration information to the S1 604a, which then retransmits the registration information to the BN 602 at step 722. BN 602 grants access to the network to TN 606 so that data communications between the two nodes may commence.

FIG. 8 is an illustrative flow chart of the PRO_REQ_S frame reduction algorithm 800 as discussed herein. The PRO_REQ_S frame reduction algorithm 800, or simply algorithm 800, may be performed at step 708 of sequence 700 by a terminal node attempting to be promoted to a switch node in response to receiving a PNPDU message from a node attempting to join a PLC network operating under the PRIME standard. At step 802, the terminal node, upon receiving a PNPDU frame, may begin to log the PNPDUs received along with their associated PNA. If, for instance, multiple nodes are joining a PLC network simultaneously or very near simultaneously (e.g., within a predetermined time threshold), each node that does not receive a beacon from a base node may transmit a PNPDU frame. The PNPDU is to prompt a node that is in data communication with a base node to request promotion to a switch node. As such, the terminal nodes receiving the PNPDUs may generate a log of all the PNPDUs received and their associated PNAs.

At block 804, the terminal node may determine if it has already established a direct connection with the base node such as a Type 3 connection request (CON_REQ_B). The Type 3 CON_REQ_B connection is a connection type defined by the PRIME standard as an acknowledged connection that updates a direct switching table, among other attributes. If the node has yet to establish such a data connection link with the base node, then the node may not request a promotion as noted by block 810. If, however, the terminal node has a Type 3 CON_REQ_B connection established with the base node, then the node moves on to block 806 for a further determination. Preventing a node that has yet to establish a Type 3 CON_REQ_B connection may reduce the number of nodes transmitting the PRO_REQ_S frames resulting in a reduction of the number of PRO_REQ_S frames transmitted around the network.

The algorithms 800 continues at block 806 with the node determining whether it is already seeking promotion or whether it has already been promoted to a switch node (e.g., in response to another attempting to join the network). In conventional PRIME networks, a node receiving a PNPDU frame may transmit a PRO_REQ_S frame to the BN 602 in response to receiving a PNPDU regardless of the state of the node, i.e., in the process of being promoted, in the process of seeking promotion, or having already been promoted. Including decision block 806 in the algorithm 800 may help reduce the number of PRO_REQ_S frames sent onto the network by reducing the number of nodes transmitting the PRO_REQ_S frames. If the node determines that it is either already seeking promotion, i.e., is in a process of sending out PRO_REQ_S frames, or has already been promoted, then the node may continue to block 810 in which it may not seek promotion. At block 810, the node does not transmit a PRO_REQ_S frame to the BN 602 despite having received a PNPDU from a node attempting to join the network. On the other hand, if the terminal node is neither actively seeking promotion nor has already been promoted, the node may continue to decision block 812.

At decision block 812 a further determination is made in accordance with the algorithm 800 to further limit the number of nodes transmitting the PRO_REQ_S frames in response to receiving a PNPDU frame. The block 812 directs the node to determine a signal-to-noise ratio (SNR) of the PNPDU frame received. In the PRIME standard, this may be the same as a link quality indicator (LQI). If the SNR is less than a threshold value, e.g., 10 dBm, then the node reverts to the block 810 and does not seek promotion. If the SNR is greater than the threshold, then the node continues on to block 814 to adjust the rate at which the node may transmit the PRO_REQ_S frames.

The algorithm 800 at block 814 calculates the rate or frequency at which the node may transmit the PRO_REQ_S frames. In some embodiments, the frequency may be a function of the number of other nodes transmitting PRO_REQ_S frames, the number of unique PNPDUs received, and a random number. For example, the node may add one to the number of PRO_REQ_S frames (N) sent onto the network by other nodes then that value may be multiplied by a random number between one and ten. The resulting value, random number [1 . . . 10]*(N+1), may be a number of PNPDUs the terminal node may receive between transmitting a PRO_REQ_S frame. The adjustment to the rate of PRO_REQ_S frame transmission is an additional reduction in the overall numbers of PRO_REQ_S frames sent onto the network. Instead of the conventional one-to-one PRO_REQ_S frame for each unique PNPDU received, the adjusted rate may govern how many PNPDUs to receive between transmitting a PRO_REQ_S frame.

Continuing at block 814, the node determines the number of PRO_REQ_S frames received from a plurality of other terminal nodes on the PLC network. Since the nodes may be connected as shown in FIG. 1, which would allow each node to detect all traffic on the network, each terminal node may be configured to periodically or continually listen to the network to detect for specific types of messages/frames, e.g., beacons, PNPDUs, PRO_RWQ_S and PRO_RSP_B, to name a few. This determination may occur in a time window beginning once a PNPDU is received. The node may detect N PRO_REQ_S frames on the network in that time window. The node may then choose a random number between 1 and 10. The chosen random number may be multiplied by N+1 resulting in some integer value. The node may transmit PRO_REQ_S frames after receiving a number of PNPDUs equal to that integer value.

For example, if the node detects 7 PRO_REQ_S frames on the network in the neighborhood, N would be 7 giving an N+1 of 8. The node may choose or have already chosen 3 as the random number. Thus, 8*3 would result in an integer value of 24. Hence, the node would need to receive 24 PNPDUs before transmitting a PRO_REQ_S frame.

After the node has calculated the adjustment it may make to the rate at which it transmits the PRO_REQ_S frames, the node may then step to decision block 816 of the algorithm 800. At block 816, the node determines if any PNPDUs with PNAs that are not already on the log have been received. If the node determines that no, there have not been any unique PNAs received since initiating the algorithm 800, then the node continues to transmit PRO_REQ_S frames at the adjusted rate. If, however, there have been unique PNAs transmit a PNPDU, then the node moves to decision block 818.

The decision block 818 determines whether the time allotted for transmitting PRO_REQ_S frames has elapsed and whether the node is still attempting to be promoted. The PRIME standard may dictate a time for transmitting the PRO_REQ_S frames, e.g., 40 seconds, and the node at the conclusion of the allotted time may discontinue transmitting the PRO_REQ_S frames. If the node determines that at least those determinations is false, then the node may loop back to block 802. In this decision step, an ongoing-promotion flag may be left at true so that the node is directed to the block 810 from the decision block 806.

If, however, BOTH of those two determinations are true, then the node changes the ongoing_promotion flag to false and starts over at the block 802. By changing the ongoing_promotion flag to false, the node may ensure that the node satisfies decision block 806 when beginning the algorithm 800 from the beginning.

As noted, the PRO_REQ_S reduction algorithm may reduce the overall number of PRO_REQ_S frames transmitted onto the network thereby reducing the overall network traffic. The PRO_REQ_S reduction algorithm may accomplish this goal by including three decisions to determine if a node should transmit PRO_REQ_S frames at all. If the outcome of those decisions is that the node can transmit PRO_REQ_S frames, then the algorithm includes a calculation to reduce or adjust the frequency at which the node may actually transmit the PRO_REQ_S frames. Therefore, on large networks with 100s of nodes, the inclusion of the algorithm in the nodes may greatly impact the overall network traffic.

For example, on a four-hop network with 84 nodes at each level, the existing PRO_REQ_S scheme may generate an average number of PRO_REQ_S frames at level three of 7 per second. In the same network setting using the PRO_REQ_S reduction algorithm, there were 0.08 PRO_REQ_S frames transmitted per second.

The algorithm attempts to reduce the overall levels in the network as well as the number of switches, while ensuring that the switches are sufficiently robust (>SNR threshold) to communicate with the new node. It also ensures that the traffic overhead during the PRO_REQ_S procedure is mitigated and that the network is stable during the promotion process.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for promoting a terminal node of a power line communication network to a switch node, comprising:
receiving, by a first terminal node of a power line communication network, a promotion needed message from a second terminal node, wherein the promotion needed message is requesting the first terminal node to seek promotion to become a switch node;
determining, by the first terminal node, whether the first terminal node has already established data connection with the base node;
determining, by the first terminal node, whether the first terminal node has not already been promoted or is not already seeking promotion to become the switch node;
determining, by the first terminal node, a signal quality level of the promotion needed message received from the second terminal node; and
based on determining that the first terminal node has already established data connection with the base node, that the first terminal node is not already seeking promotion to change to the switch mode or is not already promoted to the switch node, and that the signal quality level is above a threshold, determining, by the first terminal node, a frequency at which to transmit the promotion requests based on a number of promotion requests received from a plurality of other terminal nodes on the network and the number of promotion needed messages received, wherein a promotion request is a message from the first terminal node to the base node requesting the terminal node be changed to the switch node.

2. The method of claim 1, further comprising determining, by the first terminal node, the number of promotion requests received from the plurality of other terminal nodes on the network in response to the promotion needed message transmitted by the second terminal node.

3. The method of claim 1, further comprising logging, by the first terminal node, the received promotion needed messages.

4. The method of claim 3, wherein the promotion needed messages include a unique address associated with the second terminal node.

5. The method of claim 4, wherein determining the frequency at which to transmit the promotion requests further comprises computing the product of one plus the number of promotion requests received and a random number.

6. The method of claim 5, wherein the first terminal node transmits a promotion request after receiving a number of promotion needed requests equal to the product of one plus the number of promotion requests received and a random number.

7. The method of claim 1, wherein the signal quality is based on a signal to noise ratio of the received promotion needed message received from the second terminal node.

8. A power line communication device connected to a power line communication network, comprising:
a transceiver to transmit messages to a plurality of nodes on the network and to receive messages from the plurality of nodes on the network; and
a processor coupled to the transceiver to evaluate received messages and generate messages to transmit; and
wherein the processor, upon receiving a promotion needed message from an additional power line communication (PLC) device joining the network, is to:
determine whether data communication has already been established with a base node of the network;
determine whether the device is already seeking promotion to be a switch node or has already been promoted to the switch node;
determine a signal quality of the received promotion needed message from the additional PLC device joining the network; and
adjust a frequency at which to transmit a promotion request based on a number of promotion requests received from the plurality of other nodes on the network and a number of promotion needed messages received.

9. The device of claim 8, wherein the processor is to adjust the frequency at which to transmit the promotion request based on the processor determining that the data communication has been established, that the device is not already seeking promotion nor already been promoted, and that the signal quality of the promotion needed message is above a threshold.

10. The device of claim 8, wherein the signal quality is based on a signal to noise ratio of the received promotion needed message.

11. The device of claim 8, wherein the processor computes a product of the number of promotion requests received from the plurality of other nodes on the network and a random number.

12. The device of claim 11, wherein the processor transmits a promotion request after the number of promotion needed messages received equals the product of the number of promotion requests received from the plurality of other nodes on the network and a random number.

13. The device of claim 11, wherein the random number is a number chosen between the number one and the number ten.

14. The device of claim 8, wherein after the processor logs a unique address associated with each of the promotion needed messages received.

15. The device of claim 14, wherein the processor, after the processor adjusts a frequency at which to transmit the promotion request determines whether any additional promotion needed messages have been received from addresses not already in the log.

16. The device of claim 15, wherein the processor, based on having received additional promotion needed messages from addresses that were not already in the log, determines whether a time allotted to transmit promotion requests has expired and whether the device is already seeking promotion.

17. The device of claim 15, wherein the processor, based on not having received additional promotion needed messages from addresses that were not already in the log, continues to transmit promotion requests at the adjusted frequency until the time allotted to transmit promotion requests has expired.

18. A power line communication (PLC) modem in a PLC network containing a plurality of PLC modems, comprising:
a transceiver to receive promotion needed protocol data unit (PNPDU) frames and to transmit promotion request (PRO_REQ_S) frames, wherein a PNPDU frame may be received from a modem attempting to join the network;
a memory storing software to control the modem's actions when PNPDU frames are received; and
a processor to execute the software when PNPDU frames are received, the processor to:
determine whether the modem has already established a data communication with a base node;
determine whether the modem is already being promoted to a switch node or is already a switch node;
determine a signal quality of the received PNPDU frame; and
based on the following
(1) the data communication having already been established with the base node;
(2) the modem is not already being promoted to nor is already the switch node; and
(3) the signal quality of the received PNPDU frame is greater than a threshold;
the modem is to determine the frequency at which to transmit the PRO_REQ_S frames based on a number of PRO_REQ_S frames received from other modems on the PLC network and based on a number of PNPDU frames received from modems attempting to join the network, wherein the frequency is proportional to a number of PNPDU frames received between transmissions of the PRO_REQ_S frame by the modem.

19. The modem of claim 18, wherein the processor computes a product of the number of PRO_REQ_S frames received from other modems on the PLC network plus one and a random number.

20. The modem of claim 19, wherein the modem transmits a PRO_REQ_S frame after the number of PNPDUs received equals the product of the number of PRO_REQ_S frames received from other modems on the PLC network plus one and a random number.

21. The modem of claim 18, wherein a PNPDU frame is a request to a modem already a part of the PLC network from a node attempting to join the PLC network for the modem to request a change from a terminal node to a switch node from a base node.
